(19) United States
(12) Patent Application Publication
(10) Pub. No.: US 2013/0266081 A1
(43) Pub. Date: Oct. 10, 2013

(54) Support for Multiple Systems Using Different Modulation Schemes in PLC Networks

(71) Applicant: TEXAS INSTRUMENTS INCORPORATED, Dallas, TX (US)

(72) Inventors: Tarkesh Pande, Dallas, TX (US); Kumaran Vijayasankar, Dallas, TX (US); Ramanuja Vedantham, Allen, TX (US); Il Han Kim, Dallas, TX (US)

(73) Assignee: Texas Instruments Incorporated, Dallas, TX (US)

(21) Appl. No.: 13/859,705

(22) Filed: Apr. 9, 2013

Related U.S. Application Data
(60) Provisional application No. 61/622,305, filed on Apr. 10, 2012.

(51) Int. Cl. H04B 3/54

(52) U.S. Cl. CPC H04B 3/54
USPC 375/257

(57) ABSTRACT

Embodiments of methods and systems for using both new and older modulation schemes in PLC networks—thereby supporting legacy systems—are disclosed. In one embodiment, common frames that need to be understood by all nodes to support the network will be sent two or more times using different modulation techniques. For example, all broadcast frames, such as beacon requests, beacons, and route requests may be transmitted once with differential modulation and once with coherent modulation. In one configuration, the beacons with differential modulation may be transmitted in one beacon period, and the beacons with coherent modulation may be transmitted in another beacon period. In another configuration, the differential and coherent beacons for a particular tone mask are transmitted one after the other and before any other tone mask beacon is transmitted.

### CROSS-REFERENCE TO RELATED APPLICATIONS

This application claims the benefit of the filing date of U.S. Provisional Patent Application No. 61/622,305, which is titled “Supporting Legacy systems and New systems in PLC networks using multiple transmissions in different modulation schemes” and was filed on Apr. 10, 2012, the disclosure of which is hereby incorporated by reference herein in its entirety.

### BACKGROUND

Power line communications (PLC) include systems for communicating data over the same medium that is also used to transmit electric power to residences, buildings, and other premises, such as wires, power lines, or other conductors. In its simplest terms, PLC modulates communication signals over existing power lines. This enables devices to be networked without introducing any new wires or cables. This capability is extremely attractive across a diverse range of applications that can leverage greater intelligence and efficiency through networking. PLC applications include utility meters, home area networks, and appliance and lighting control.

PLC is a generic term for any technology that uses power lines as a communications channel. Various PLC standardization efforts are currently in work around the world. The different standards focus on different performance factors and issues relating to particular applications and operating environments. Two of the most well-known PLC standards are G3 and PRIME. G3 has been approved by the International Telecommunication Union (ITU). IEEE is developing the IEEE P1901.2 standard that is based on G3. Each PLC standard has its own unique characteristics.

Using PLC to communicate with utility meters enables applications such as Automated Meter Reading (AMR) and Automated Meter Infrastructure (AMI) communications without the need to install additional wires. Consumers may also use PLC to connect home electric meters to an energy monitoring device or in-home display monitor their energy consumption and to leverage lower-cost electric pricing based on time-of-day demand.

As the home area network expands to include controlling home appliances for more efficient consumption of energy, OEMs may use PLC to link these devices and the home network. PLC may also support home and industrial automation by integrating intelligence into a wide variety of lighting products to enable functionality such as remote control of lighting, automated activation and deactivation of lights, monitoring of usage to accurately calculate energy costs, and connectivity to the grid.

The manner in which PLC systems are implemented depends upon local regulations, characteristics of local power grids, etc. The frequency band available for PLC users depends upon the location of the system. In Europe, PLC bands are defined by the CENELEC (European Committee for Electrotechnical Standardization). The CENELEC-A band (3 kHz-95 kHz) is exclusively for energy providers. The CENELEC-B, C, D bands are open for end user applications, which may include PLC users. Typically, PLC systems operate between 35-90 kHz in the CENELEC A band using 36 tones spaced 1.5675 kHz apart. In the United States, the FCC has conducted emissions requirements that start at 535 kHz and therefore the PLC systems have an FCC band defined from 154-487.5 kHz using 72 tones spaced at 4.6875 kHz apart. In other parts of the world different frequency bands are used, such as the Association of Radio Industries and Businesses (ARIB)-defined band in Japan, which operates at 10-450 kHz, and the Electric Power Research Institute (EPRI)-defined bands in China, which operates at 3-90 kHz.

Multi-Tone Mask (MTM) mode (or “tone masking”) refers to the use of multiple tone masks/sub-bands to enable nodes in the network to use individual tone masks within the band optimized for the local conditions on the network. PLC networks may typically use network communication protocols based on the IEEE P1901.2. MTM mode for tones allows avoidance of parts of the network spectrum occupied by high levels of external noise and allows for each router-node pair to select the optimal tone mask for communication. MTM mode also allows co-existence with incumbent communication technologies that might be sharing the PLC channel.

It is well known that coherent modulation improves performance and, therefore, may help improve network coverage. However, in some PLC networks, the use of coherent modulation is not mandatory because it is not supported in many legacy systems. Also, since beacon frames cannot use coherent modulation, the benefits of coherent modulation are not available to such networks. Existing schemes prevent networks from using new modulation techniques or other techniques for common control messages since the legacy systems cannot support these new techniques.

As a result, for a network to accommodate both legacy systems, which cannot support coherent modulation, and new systems with coherent modulation, then commonly used frames, such as beacon frames, and other control packets, such as route request (RREQ) frames, must be sent using differential modulation. In such systems, only unicast frames may use coherent modulation and, even then, only if a source device knows that a destination device supports coherent modulation.

### SUMMARY OF THE INVENTION

The proposed solution helps improve network coverage by using new frame transmission schemes that still support legacy systems.

In one embodiment, a system and method for supporting legacy nodes and advanced nodes in a power line communication (PLC) network is disclosed. A set of common frames are transmitted in a legacy mode to nodes in the PLC network. The legacy mode is understood by (e.g., demodulated, deciphered, etc.) and can be utilized by both the legacy nodes and the advanced nodes. The set of common frames are also transmitted in an advanced mode to the nodes in the PLC network. The legacy mode may be a differential modulation mode, while the advanced mode may be a coherent modulation mode.

The set of legacy mode common frames may be interleaved with the set of advanced mode common frames for transmission in one embodiment. In other embodiments, all of the common frames in one mode may be transmitted before transmitting the common frames in a second mode. For example, a set of common frames may be first transmitted using differential modulation, and then a second set of some or all of the common frames may be transmitted using coherent modulation. The PLC network may be a non-beacon mode network, a beacon mode network, or may operate in a multi-tone mask mode, for example.

The legacy mode common frames and the advanced mode common frames may be generated by a power line communication router, for example, and transmitted by a power line communication modem.

Embodiments of methods and systems for using both new and older modulation schemes in PLC networks—thereby supporting legacy systems—are presented. In one embodiment, common frames that need to be understood by all nodes to support the network will be sent two or more times using different modulation techniques. For example, all broadcast frames, such as beacon requests, beacons, and route requests may be transmitted once with differential modulation and once with coherent modulation. The proposed scheme may be used with other variations where a legacy system does not support a certain type of frame transmission.

### BRIEF DESCRIPTION OF THE DRAWINGS

Having thus described the invention in general terms, reference will now be made to the accompanying drawings, wherein:

FIG. 1 is a diagram of a PLC system according to some embodiments.

FIG. 2 is a block diagram of a PLC device or modem according to some embodiments.

FIG. 3 is a block diagram of a PLC gateway according to some embodiments.

FIG. 4 is a block diagram of a PLC data concentrator according to some embodiments.

FIG. 5 is a schematic block diagram illustrating one embodiment of a system configured for point-to-point PLC.

FIG. 6 is a block diagram of an integrated circuit according to some embodiments.

FIG. 7 illustrates a superframe structure for existing PLC networks according to one embodiment.

FIG. 8 illustrates a modified portion of a superframe structure according to one embodiment.

FIG. 9 illustrates a modified portion of a superframe structure according to another embodiment.

FIG. 10 is a flowchart of a method or process for multi-tone mask communication using beacons in multiple transmission modes.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

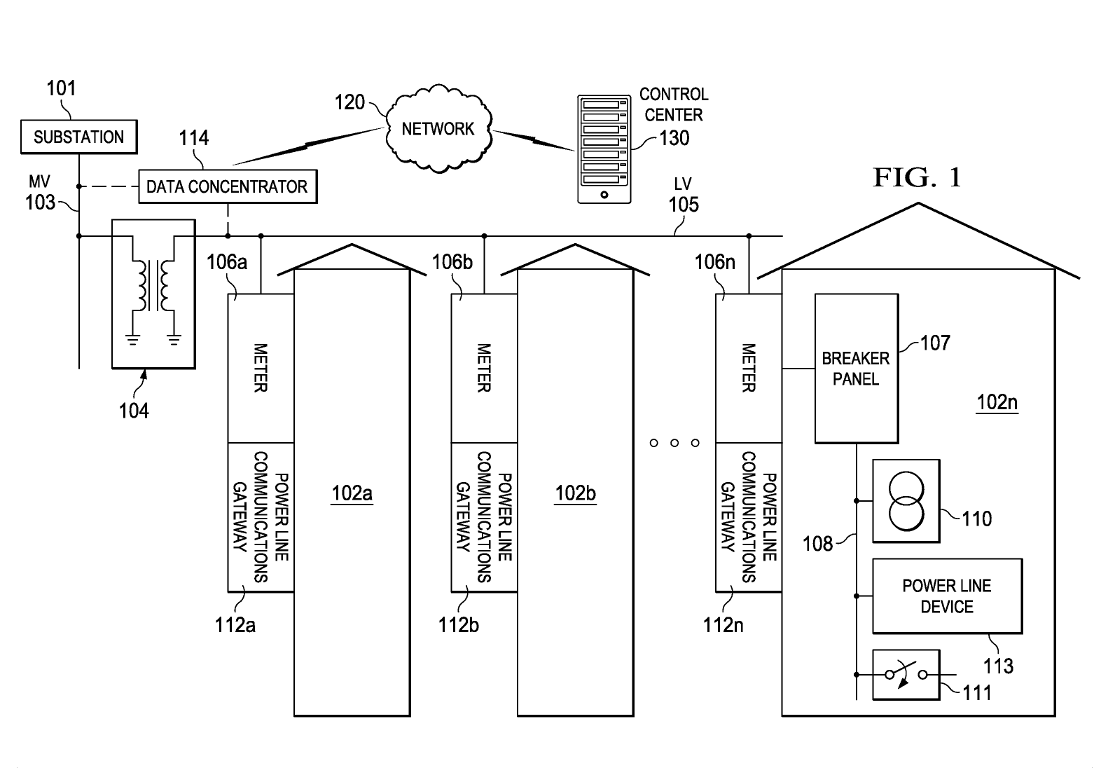

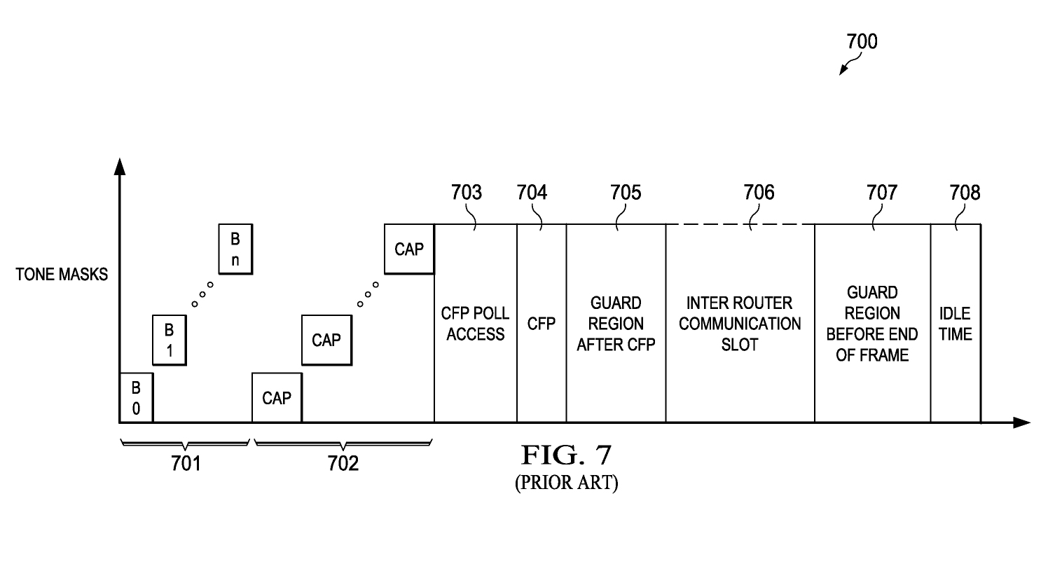

A coordinator or router in a PLC network transmits common frames, such beacon requests, beacons, and route request messages, using both differential modulation and coherent modulation. In one embodiment of the present invention, a router transmits sequential beacon frames using differential and coherent modulation on each tone mask. In another embodiment, the router transmits beacon frames using differential modulation on all of the tone masks and then transits another set of beacon frames using coherent modulation on each tone mask. An example of such a system is described below in FIGS. 7-10. FIGS. 1-6 describe the G3-PLC systems and methods generally.

FIG. 1 illustrates a power line communication system having overlapping priority contention windows in G3-PLC networks according to some embodiments. Medium voltage (MV) power lines 103 from subnode 101 typically carry voltage in the tens of kilovolts range. Transformer 104 steps the MV power down to low voltage (LV) power on LV lines 105, carrying voltage in the range of 100-240 VAC. Transformer 104 is typically designed to operate at very low frequencies in the range of 50-60 Hz. Transformer 104 does not typically allow high frequencies, such as signals greater than 100 KHz, to pass between LV lines 105 and MV lines 103. LV lines 105 feed power to customers via meters or nodes 106a-n, which are typically mounted on the outside of residences 102a-n. Although referred to as “residences,” premises 102a-n may include any type of building, facility, electric vehicle charging node, or other location where electric power is received and/or consumed. A breaker panel, such as panel 107, provides an interface between meter 106n and electrical wires 108 within residence 102n. Electrical wires 108 deliver power to outlets 110, switches 111 and other electric devices within residence 102n.

The power line topology illustrated in FIG. 1 may be used to deliver high-speed communications to residences 102a-n. In some implementations, power line communications modems or gateways 112a-n may be coupled to LV power lines 105 at meter 106a-n. PLC modems/gateways 112a-n may be used to transmit and receive data signals over MV/LV lines 103/105. Such data signals may be used to support metering and power delivery applications (e.g., smart grid applications), communication systems, high speed Internet, telephony, video conferencing, and video delivery, to name a few. By transporting telecommunications and/or data signals over a power transmission network, there is no need to install new cabling to each subscriber 102a-n. Thus, by using existing electricity distribution systems to carry data signals, significant cost savings are possible.

An illustrative method for transmitting data over power lines may use a carrier signal having a frequency different from that of the power signal. The carrier signal may be modulated by the data, for example, using an OFDM technology or the like described, for example, G3-PL standard.

PLC modems or gateways 112a-n at residences 102a-n use the MV/LV power grid to carry data signals to and from PLC data concentrator or router 114 without requiring additional wiring. Data concentrator or router 114 may be coupled to either MV line 103 or LV line 105. Modems or gateways 112a-n may support applications such as high-speed broadband Internet links, narrowband control applications, low bandwidth data collection applications, or the like. In a home environment, for example, modems or gateways 112a-n may further enable home and building automation in heat and air conditioning, lighting, and security. Also, PLC modems or gateways 112a-n may enable AC or DC charging of electric vehicles and other appliances. An example of an AC or DC charger is illustrated as PLC device 113. Outside the premises, power line communication networks may provide street lighting control and remote power meter data collection.

One or more PLC data concentrators or routers 114 may be coupled to control center 130 (e.g., a utility company) via network 120. Network 120 may include, for example, an IP-based network, the Internet, a cellular network, a WiFi network, a WiMax network, or the like. As such, control center 130 may be configured to collect power consumption and other types of relevant information from gateway(s) 112 and/or device(s) 113 through concentrator(s) 114. Additionally or alternatively, control center 130 may be configured to implement smart grid policies and other regulatory or commercial rules by communicating such rules to each gateway(s) 112 and/or device(s) 113 through concentrator(s) 114.

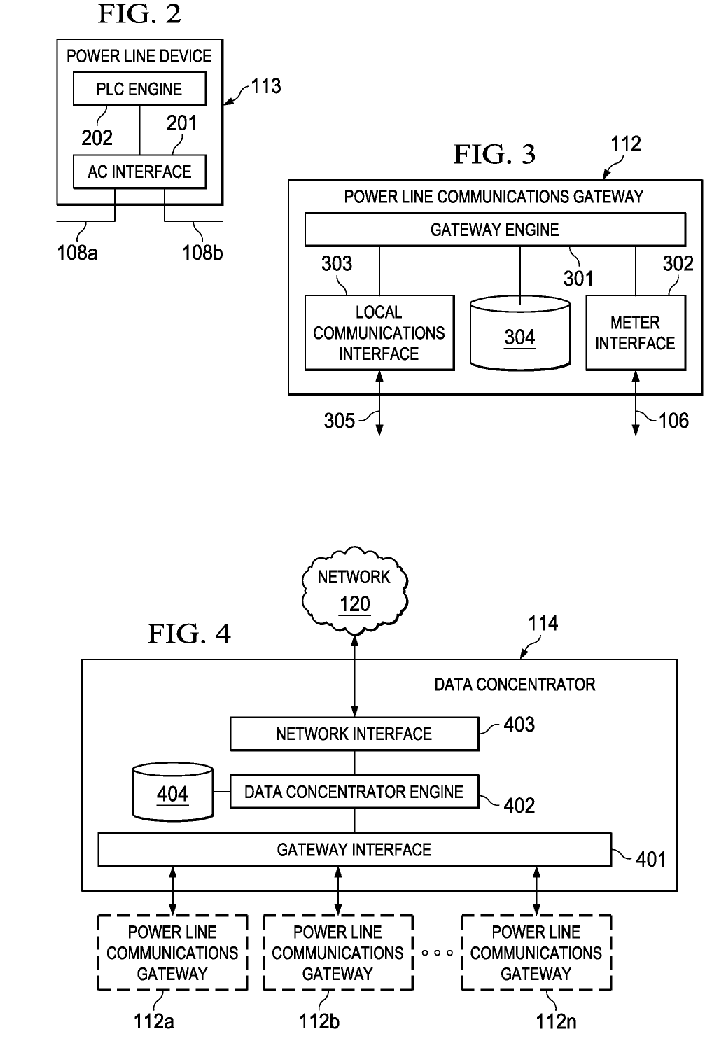

FIG. 2 is a block diagram of PLC device 113 according to some embodiments. As illustrated, AC interface 201 may be coupled to electrical wires 108a and 108b inside of premises 112n in a manner that allows PLC device 113 to switch the connection between wires 108a and 108b off using a switching circuit or the like. In other embodiments, however, AC interface 201 may be connected to a single wire 108 (i.e., without breaking wire 108 into wires 108a and 108b) and without providing such switching capabilities. In operation, AC interface 201 may allow PLC engine 202 to receive and transmit PLC signals over wires 108a-b. In some cases, PLC device 113 may be a PLC modem. Additionally or alternatively, PLC device 113 may be a part of a smart grid device (e.g., an AC or DC charger, a meter, etc.), an appliance, or a control module for other electrical elements located inside or outside of premises 112n (e.g., street lighting, etc.).

PLC engine 202 may be configured to transmit and/or receive PLC signals over wires 108a and/or 108b via AC interface 201 using a particular frequency band. In some embodiments, PLC engine 202 may be configured to transmit OFDM signals, although other types of modulation schemes may be used. As such, PLC engine 202 may include or otherwise be configured to communicate with metrology or monitoring circuits (not shown) that are in turn configured to measure power consumption characteristics of certain devices or appliances via wires 108, 108a, and/or 108b. PLC engine 202 may receive such power consumption information, encode it as one or more PLC signals, and transmit it over wires 108, 108a, and/or 108b to higher-level PLC devices (e.g., PLC gateways 112n, data aggregators 114, etc.) for further processing. Conversely, PLC engine 202 may receive instructions and/or other information from such higher-level PLC devices encoded in PLC signals, for example, to allow PLC engine 202 to select a particular frequency band in which to operate.

FIG. 3 is a block diagram of PLC gateway 112 according to some embodiments. As illustrated in this example, gateway engine 301 is coupled to meter interface 302, local communication interface 304, and frequency band usage database 304. Meter interface 302 is coupled to meter 106, and local communication interface 304 is coupled to one or more of a variety of PLC devices such as, for example, PLC device 113. Local communication interface 304 may provide a variety of communication protocols such as, for example, ZigBee, Bluetooth, Wi-Fi, Wi-Max, Ethernet, etc., which may enable gateway 112 to communicate with a wide variety of different devices and appliances. In operation, gateway engine 301 may be configured to collect communications from PLC device 113 and/or other devices, as well as meter 106, and serve as an interface between these various devices and PLC data concentrator 114. Gateway engine 301 may also be configured to allocate frequency bands to specific devices and/or to provide information to such devices that enable them to self-assign their own operating frequencies.

In some embodiments, PLC gateway 112 may be disposed within or near premises 102n and serve as a gateway to all PLC communications to and/or from premises 102n. In other embodiments, however, PLC gateway 112 may be absent and PLC devices 113 (as well as meter 106n and/or other appliances) may communicate directly with PLC data concentrator 114. When PLC gateway 112 is present, it may include database 304 with records of frequency bands currently used, for example, by various PLC devices 113 within premises 102n. An example of such a record may include, for instance, device identification information (e.g., serial number, device ID, etc.), application profile, device class, and/or currently allocated frequency band. As such, gateway engine 301 may use database 305 in assigning, allocating, or otherwise managing frequency bands assigned to its various PLC devices.

FIG. 4 is a block diagram of PLC data concentrator or router 114 according to some embodiments. Gateway interface 401 is coupled to data concentrator engine 402 and may be configured to communicate with one or more PLC gateways 112a-n. Network interface 403 is also coupled to data concentrator engine 402 and may be configured to communicate with network 120. In operation, data concentrator engine 402 may be used to collect information and data from multiple gateways 112a-n before forwarding the data to control center 130. In cases where PLC gateways 112a-n are absent, gateway interface 401 may be replaced with a meter and/or device interface (now shown) configured to communicate directly with meters 116a-n, PLC devices 113, and/or other appliances. Further, if PLC gateways 112a-n are absent, frequency usage database 404 may be configured to store records similar to those described above with respect to database 304.

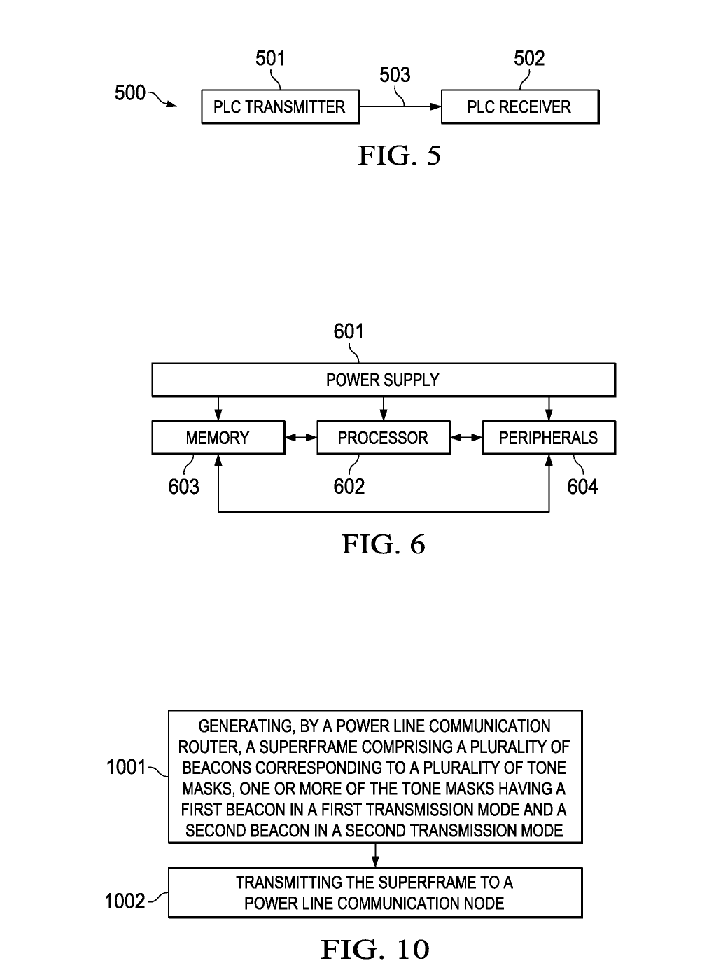

FIG. 5 is a schematic block diagram illustrating one embodiment of a system 500 configured for point-to-point PLC. The system 500 may include a PLC transmitter 501 and a PLC receiver 502. For example, a PLC gateway 112 may be configured as the PLC transmitter 501 and a PLC device 113 may be configured as the PLC receiver 502. Alternatively, the PLC device 113 may be configured as the PLC transmitter 501 and the PLC gateway 112 may be configured as the PLC receiver 502. In still a further embodiment, the data concentrator 114 may be configured as either the PLC transmitter 501 or the PLC receiver 502 and configured in combination with a PLC gateway 112 or a PLC device 113 in a point-to-point system 500. In still a further embodiment, a plurality of PLC devices 113 may be configured to communicate directly in a point-to-point PLC system 500 as described in FIG. 5. Additionally, the subnode 101 may be configured in a point-to-point system 500 as described above. On of ordinary skill in the art will recognize a variety of suitable configurations for the point-to-point PLC system 500 described in FIG. 5.

FIG. 6 is a block diagram of a circuit for implementing the transmission of multiple beacon frames using different modulation techniques on each tone mask in a PLC network according to some embodiments. In some cases, one or more of the devices and/or apparatuses shown in FIGS. 1-5 may be implemented as shown in FIG. 6. In some embodiments, processor 602 may be a digital signal processor (DSP), an application specific integrated circuit (ASIC), a system-on-chip (SoC) circuit, a field-programmable gate array (FPGA), a microprocessor, a microcontroller, or the like. Processor 602 is coupled to one or more peripherals 604 and external memory 603. In some cases, external memory 603 may be used to store and/or maintain databases 304 and/or 404 shown in FIGS. 3 and 4. Further, processor 602 may include a driver for communicating signals to external memory 603 and another driver for communicating signals to peripherals 604. Power supply 601 provides supply voltages to processor 602 as well as one or more supply voltages to memory 603 and/or peripherals 604. In some embodiments, more than one instance of processor 602 may be included (and more than one external memory 603 may be included as well).

Peripherals 604 may include any desired circuitry, depending on the type of PLC system. For example, in an embodiment, peripherals 604 may implement local communication interface 303 and include devices for various types of wireless communication, such as Wi-Fi, ZigBee, Bluetooth, cellular, global positioning system, etc. Peripherals 604 may also include additional storage, including RAM storage, solid-state storage, or disk storage. In some cases, peripherals 604 may include user interface devices such as a display screen, including touch display screens or multi-touch display screens, keyboard or other input devices, microphones, speakers, etc.

External memory 603 may include any type of memory. For example, external memory 603 may include SRAM, nonvolatile RAM (NVRAM, such as “flash” memory), and/or dynamic RAM (DRAM) such as synchronous DRAM (SDRAM), double data rate (DDR, DDR2, DDR3, etc.) SDRAM, DRAM, etc. External memory 603 may include one or more memory modules to which the memory devices are mounted, such as single inline memory modules (SIMMs), dual inline memory modules (DIMMs), etc.

FIG. 7 illustrates a superframe structure for existing PLC networks according to one embodiment. In accordance with various embodiments, the superframe 700 may include the following regions: a beacon region 701; a contention access region (CAP) 702; a contention free period (CFP) poll access region 703; a CFP 704; a guard region after CFP 705; an inter router communication slot (IRCS) region 706; a guard region before end of frame 707; and an idle time region 708. The regions 701-708 may be used in the sequence listed or may be used in other sequences. Additionally, not all regions are always utilized. The superframe structure may be dictated to the network by a local utility via a master router, for example. However, each router may have some autonomy within each of the regions so long as the beginning and ending of each region is synchronized across network.

The illustrating superframe 700 of FIG. 7 provides tone mask assignments and timing assignments for the various regions which enables MTM mode operation in a PLC network, such as the PLC network depicted in FIG. 1. The superframe 700 is useful for cases where the MTM mode is applied to an MV-LV application where an MV node operates as a router 114, and nodes 106a-n try to associate with router 114, and the routers 114 and nodes 106a-n communicate with one another through their respective transformers 104.

Superframe 700 includes a plurality of beacon frames (B1, B2, . . . BN) within a beacon period 701. A beacon frame corresponds to each of the available N tone masks. If the PLC network's available full mask is divided into N tone masks, then there are thus N beacon frames in N beacon slots with one beacon frame for each tone mask available or allotted. The beacons (B1, B2, . . . BN) include time and sequencing assignments within the superframe including time assignments for the CAP slots 702 and for the CFP period 704, and tone mask assignments for the N tone masks in the CAP slots 702, the CFP poll access region 703, the CFP region 704, the two guard regions 705, 707, the inter router communication slot 706, the idle time region 708, as well as a conventional timestamp for local clock synchronization, beacon interval information, device/network capability information, whether polling is supported, and encryption details.

Superframe 700 includes CAP region 702 including multiple CAP slots, with one CAP slot allocated for each of the N tone masks and corresponding to one of the N beacons. Each CAP slot is also characterized by its own minimum length of symbols, which is a function of the associated tone mask. A minimum length is required because the number of symbols needed to carry a joining request frame depends on the frequency of the tone mask. Tone masks that have a smaller number of tones, shorter frequencies, take longer to transmit and require more symbols whereas tone masks with a larger number of tones, higher frequencies, require fewer symbols to communicate the same information. Thus, the length of the CAP slot is inversely related to the tone mask.

A CFP poll access period 703 is also included in superframe 700, during which routers, such as router 114, contend for access to use the CFP 704. CFP 704 refers to contention-free access where the router that won contention during CFP poll access period 703 transmits requests for data to the nodes and the nodes respond with any available data. For example, if router 114 won contention, then it would poll nodes 106a-n during CFP 704 requesting data. Superframe 700 may also include guard region after CFP 705, which is used to conclude any communications lagging from CFP 704. Guard region 705 is also used to ensure that routers are synchronized at the start of IRCS 706. IRCS 706 is used for routers to communicate with each other, which may include a master router requesting data from other routers to forward on to a local utility via a backbone. IRCS 706 may also be used for a master router to transmit a new format to superframe 700 to the routers and nodes of the network. Communication that occurs during IRCS 706 may use the full band, the full tone mask, for transmissions, not just a single sub-band or tone mask.

Superframe 700 also includes another guard region after IRCS 706. Guard region before end of frame 707 may be used to conclude transmissions between the routers. Superframe 700 then concludes with idle time 708. Idle time 708 is used by the devices of the PLC network to complete tasks not requiring any transmissions on the network. Idle time 708 may also be used to transition to a lower power mode or to perform local updates. Nodes may use idle time 708 to gather data from energy thirsty components at the node level, such as car charging stations, appliances, etc. The idle time 708's length and sequence within superframe 700 is fully described in at least one beacon or may be described in each beacon. In various other embodiments, idle time 708 start time and end time will be described in at least one of the N beacons of beacon frame 701.

As discussed previously, superframe 700's structure, i.e., the length of each region and the sequence of the regions, can be altered by the local utility at any time. Changes to superframe 700 will be communicated to the other routers and the nodes of the network by a master router. Additionally, each region of superframe 700 may not always be required and additional regions may be inserted that allows for other types of communication. Moreover, although a master router dictates the overall structure of superframe 700, each router may alter the number and timing of the N beacons and N CAP slots used in its neighborhood so long as CFP poll access region 703 is synchronized for the entire network.

In router-to-node communications, the tone mask that is used for the uplink and downlink direction may be different. Uplink (UL) refers to the communication from a node to the router, while downlink (DL) refers to the communication from the router to the node. To operate in this mode, the number of beacon slots 701 and CAP slots 702 is equal to the number of tone masks in the system. Each beacon slot 701 and CAP slot 702 is assigned for one tone mask. When started, each node device on the PLC network will perform a passive scan—referred to as tone mask scanning—to find the optimal DL and UL tone masks. Once optimal tone masks are determined, the device will operate in steady state on the optimal tone mask. The allocated tone masks may be updated using a tone mask update process initiated by the router (or coordinator) at any time.

Each beacon slot 701 and CAP slot 702 is assigned to a particular tone-mask in an arbitrary order as chosen by the router. There is only one beacon slot 701 or CAP slot 702 for a particular tone mask in a superframe 700. The router indicates the sequence of beacon slots 701 using a bit map in the beacons. The number of beacon slots 701 and CAP slots 702 in the superframe 700 is kept equal to the number of tone masks in the system.

The CAP duration must be kept to at least a minimum number of symbols to allow the new nodes to join the network using that particular tone mask. Once the uplink (node to router) and downlink (router to node) tone masks are determined, normal data transfer may happen. Every node tunes its receiver to the tone mask corresponding to the CAP slot during the CAP slot period 702.

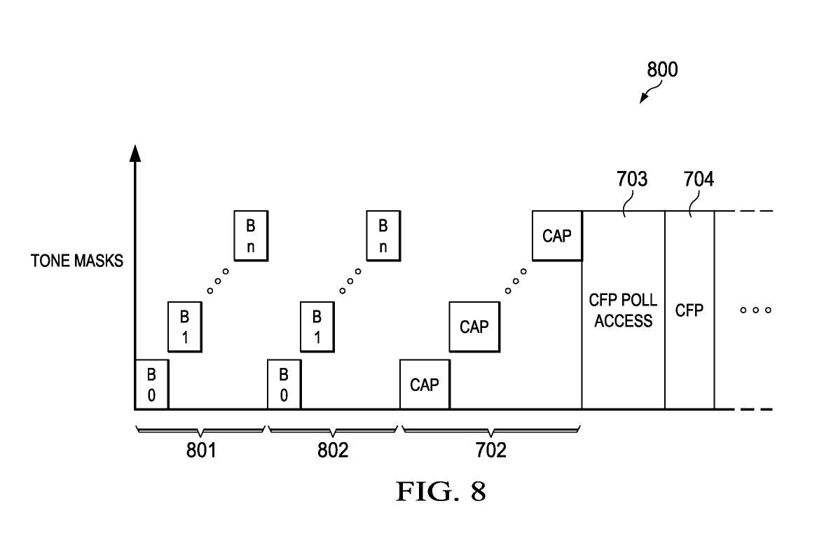

FIG. 8 illustrates a modified portion of a superframe structure according to one embodiment. Instead of transmitting beacons just once in superframe 800, the beacons for each tone mask are transmitted using two different modulation schemes. The beacons in beacon period 801 are transmitted using a first modulation type, and the beacons in additional beacon period 802 are transmitted using a second modulation type. For example, one set of beacons is transmitted using differential modulation, while the other set of beacons is transmitted using coherent modulation.

In existing superframe 700 (FIG. 7), the beacons are transmitted using differential modulation. An additional beacon transmission slot may be added before or after the differential modulation beacon slot. The beacons in the additional slot are transmitted using coherent modulation.

In one embodiment, timing information regarding the start and stop of the beacon slots are included in each beacon. When a legacy node receives a differential beacon, it will understand the time corresponding to beacon transmission in coherent mode and, therefore, will not transmit during that time.

In other embodiments, if a node supports coherent mode modulation, then it may potentially get both beacons for the tone mask.

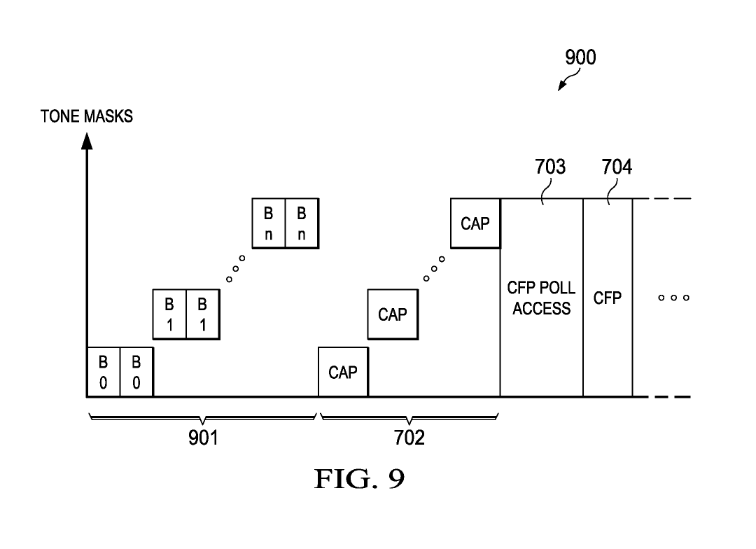

FIG. 9 illustrates a modified portion of a superframe structure 900 according to another embodiment. The beacons for each tone mask are transmitted using two different modulation schemes. Instead of separating the beacons into a coherent beacon period and a differential period (e.g., 801, 802 in FIG. 8), the differential and coherently modulated beacons are transmitted one after the other in each tone mask in a single beacon period 901.

In a PLC system using superframe 900, legacy systems set their beacon wait time to double the beacon transmission time so that they receive both the differential and coherently modulated beacons.

In the IEEE 1901.2 and G3 standards, common frames include: beacon requests, beacons, and route request (RREQ) frames. A new node in the PLC network will not know if existing nodes use differential modulation or coherent modulation. Accordingly, a new node will transmit both the differential and coherently modulated beacons and the differential and coherently modulated RREQ frames. The receiving node will decode the beacon and RREQ frames corresponding to its modulation type and will reply using that modulation type.

In some embodiments, the number of coherently modulated beacons may be the same as or different from the number of differentially modulated beacons. For example, the number of coherently modulated beacons may be less than that of the differentially modulated beacons in some PLC networks. The information regarding the number and placement of such beacons may be included in the beacon frames.

FIG. 10 is a flowchart of a method or process for multi-tone mask communication using beacons in multiple transmission modes. In step 1001, a power line communication router generates a superframe. The superframe comprises a plurality of beacons corresponding to a plurality of tone masks. One or more of the tone masks have a first beacon in a first transmission mode and a second beacon in a second transmission mode. In step 1002, the superframe is transmitted to a power line communication node. The superframe may be transmitted via a modem, for example.

In one embodiment, the first transmission mode may be a differential modulation mode and the second transmission mode may be a coherent modulation mode. The beacons corresponding to the first transmission mode may be grouped in a first beacon period of the superframe and the beacons corresponding to the second transmission mode grouped in a second beacon period of the superframe.

In another embodiment, the second transmission mode beacons are transmitted after the corresponding first transmission mode beacons, and before a beacon is transmitted in another tone mask.

In further embodiment, both legacy nodes and advanced nodes are supported in a power line communication network. A set of common frames are transmitted in a legacy mode to nodes in the PLC network. The legacy mode is understood by and can be utilized by both the legacy nodes and the advanced nodes. The set of common frames are also transmitted to the nodes in the PLC network in an advanced mode to exploit the use of advanced features. The legacy mode may be a differential modulation mode, while the advanced mode may be a coherent modulation mode. The advanced features may include, for example, a coherent mode, a preamble with additional repetitions, a packet with better error encoding, or any PHY-level feature that helps to decode the packet at a worse channel conditions.

The set of legacy mode common frames may be interleaved with the set of advanced mode common frames for transmission in one embodiment. In other embodiments, all of the common frames in one mode may be transmitted before transmitting the common frames in a second mode. For example, a set of common frames may be first transmitted using differential modulation, and then a second set of some or all of the common frames may be transmitted using coherent modulation. The PLC network may be a non-beacon mode network, a beacon mode network, or may operate in a multi-tone mask mode, for example.

The legacy mode common frames and the advanced mode common frames may be generated by a power line communication router, for example, and transmitted by a power line communication modem.

Many modifications and other embodiments of the invention(s) will come to mind to one skilled in the art to which the invention(s) pertain having the benefit of the teachings presented in the foregoing descriptions, and the associated drawings. Therefore, it is to be understood that the invention(s) are not to be limited to the specific embodiments disclosed. Although specific terms are employed herein, they are used in a generic and descriptive sense only and not for purposes of limitation.

What is claimed is:

1. A method for supporting legacy nodes and advanced nodes in a power line communication (PLC) network, comprising:
transmitting a set of common frames in a legacy mode to nodes in the PLC network, the legacy mode utilized by both the legacy nodes and the advanced nodes; and
transmitting the set of common frames in an advanced mode to the nodes in the PLC network to exploit the use of advanced features.

2. The method of claim 1, wherein the legacy mode is a differential modulation mode and the advanced mode is a coherent modulation mode.

3. The method of claim 1, further comprising:
interleaving the set of legacy mode common frames and the set of advanced mode common frames for transmission.

4. The method of claim 1, further comprising:
transmitting all of the common frames in one mode before transmitting the other set of common frames in a second mode.

5. The method of claim 1, wherein the PLC network is a non-beacon mode network.

6. The method of claim 1, wherein the PLC network is a beacon mode network.

7. The method of claim 1, wherein the PLC network operates in a multi-tone mask mode.

8. The method of claim 1, further comprising:
generating the set of legacy mode common frames and the set of advanced mode common frames by a power line communication router.

9. A system for supporting legacy nodes and advanced nodes in a power line communication (PLC) network, comprising:
a processor configured to generate a set of common frames in a legacy mode and a set of the common frames in an advanced mode, the legacy mode utilized by both the legacy nodes and the advanced nodes; and
a modem coupled to the processor and configured to transmit the legacy mode common frames and the advanced mode common frames to nodes in the PLC network.

10. The system of claim 9, wherein the legacy mode is a differential modulation mode and the advanced mode is a coherent modulation mode.

11. The system of claim 9, wherein the processor is further configured to:
interleave the set of legacy mode common frames and the set of advanced mode common frames prior to transmission by the modem.

12. The system of claim 9, wherein the processor is further configured to:
transmit all of the common frames in one mode before transmitting the other set of common frames in a second mode.

13. The system of claim 9, wherein the processor and modem are components of a power line communication router.

14. A system for power line communications using a multi-tone mask, comprising:
a processor configured to generate a superframe comprising a plurality of beacons corresponding to a plurality of tone masks, one or more of the tone masks having a first beacon in a first transmission mode and a second beacon in a second transmission mode; and
a modem coupled to the processor and configured to transmit the superframe to a node.

15. The system of claim 14, wherein the first transmission mode is a differential modulation mode and the second transmission mode is a coherent modulation mode.

16. The system of claim 14, wherein the beacons corresponding to the first transmission mode are grouped in a first beacon period of the superframe and the beacons corresponding to the second transmission mode are grouped in a second beacon period of the superframe.

17. The system of claim 14, wherein the processor interleaves the first and second transmission mode beacons before transmitting the beacons.

18. A method for multi-tone mask communication, comprising:
generating, by a power line communication router, a superframe comprising a plurality of beacons corresponding to a plurality of tone masks, one or more of the tone masks having a first beacon in a first transmission mode and a second beacon in a second transmission mode; and
transmitting the superframe to a power line communication node.

19. The method of claim 18, wherein the first transmission mode is a differential modulation mode and the second transmission mode is a coherent modulation mode.

20. The method of claim 18, wherein the beacons corresponding to the first transmission mode are grouped in a first beacon period of the superframe and the beacons corresponding to the second transmission mode are grouped in a second beacon period of the superframe.

21. The method of claim 18, wherein in each tone mask the second transmission mode beacons are transmitted after the corresponding first transmission mode beacons and before a beacon is transmitted in another tone mask.
